(19) United States
(12) Patent Application Publication
(10) Pub. No.: US 2017/0160767 A1
(43) Pub. Date: Jun. 8, 2017

(54) LAPTOP DOCKING SYSTEM AND METHOD

(71) Applicant: TreVante Jones, Glenn Dale, MD (US)

(72) Inventor: TreVante Jones, Glenn Dale, MD (US)

(21) Appl. No.: 15/363,259

(22) Filed: Nov. 29, 2016

Related U.S. Application Data
(60) Provisional application No. 62/263,013, filed on Dec. 4, 2015.

(51) Int. Cl. G06F 1/16; G06F 13/38; G06F 13/40

(52) U.S. Cl. CPC G06F 1/1616; G06F 13/4081; G06F 13/385; G06F 1/1632

(57) ABSTRACT

A docking system includes a customizable attachable housing, at least one hot swappable PnP hard drive dock, and a power supply. The docking system is useful for allowing a user to transfer data from multiple laptops across different manufacturers to a single docking system which houses a variety of storage and duplication options.

### CROSS-REFERENCE TO RELATED APPLICATION

The present application is related to and claims priority to U.S. Provisional Patent Application No. 62/263,013 filed Dec. 4, 2015, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

1. Field of the Invention

The present invention relates generally to the field of lap-top expansion and more specifically relates to a proprietary hot swappable drive system for multiple lap-top manufactures.

2. Description of Related Art

Many people use lap-tops to work and store information, often filling up the internal hard drive space rather quickly, especially in the music and video industry. Many professionals have multiple lap-tops they use for different jobs. Sometimes information needs to be shared between lap-tops on specific work. Sharing information across different lap-tops can be difficult due to the proprietary nature of different lap-top manufacturers. Currently, the only option available is to carry around large external USB hard drives formatted in multiple file structures. When traveling, and dealing with large files, the size of the external hard drive and toting an extra piece of hardware around is cumbersome. Therefore a suitable solution is desired.

U.S. Pat. No. 6,594,721 to Premanand Sakarda, et al., relates to a surprise hot bay swapping of IDE/ATAPI devices. The described surprise hot bay swapping of IDE/ATAPI devices includes A system for allowing surprise insertion and removal of a peripheral device from the bays of a portable computer system. The peripheral device may be inserted or removed when the portable computer system is powered off, powered on, or in standby or sleep mode. The peripheral device may be any one of a multitude of devices corresponding to the IDE, ATAPI or FLOPPY standard.

### BRIEF SUMMARY OF THE INVENTION

In view of the foregoing disadvantages inherent in the known proprietary hot swappable drive system for multiple lap-top manufactures art, the present disclosure provides a novel laptop docking system. The general purpose of the present disclosure, which will be described subsequently in greater detail, is to provide a laptop docking system.

A docking system is disclosed herein. The docking system includes a customizable attachable housing useful for connecting to a variety of different manufactured lap-tops, at least one hot swappable PnP drive dock, and a power supply.

The docking system includes a customizable attachable housing useful for connecting to a variety of different manufactured laptops, at least one hot swappable PnP drive dock, and a power supply. According to this embodiment, the customizable attachable housing includes at least one hot swappable PnP media duplication drive. According to this embodiment, the customizable attachable housing further includes at least one universal serial bus port useful for connecting to the lap-top computer. According to this embodiment, the at least one universal serial bus port is USB 3.0 compatible for increased data transfer speeds to USB 3.0 compatible devices. According to this embodiment, the customizable attachable housing further includes a HDMI output port allowing for a user to output data to an auxiliary monitor. The customizable attachable housing further includes a dual-protocol I/O connection port allowing for non-PC compatible storage drive connections. The customizable attachable housing further includes a fire wire connection port to maintain backward compatibility. According to this embodiment, the customizable attachable housing also includes a parallel port useful for allowing a user to connect to a printer. The customizable attachable housing includes a microphone input port for inputting and saving voice recordings. The customizable attachable housing includes an optical audio port for improved audio sound production.

The at least one hot swappable PnP drive dock is suitable to be coupled to a SSD drive allowing for an increase in speed when saving and retrieving data through the docking system. The at least one hot swappable PnP drive dock includes a connection port incorporating Serial AT Attachment for HDD, and SSD coupling. The at least one hot swappable PnP drive dock includes a connection port incorporating Serial AT Attachment for HDD, and SSD coupling.

According to this embodiment, the at least one hot swappable PnP media duplication drive supports DVD technology and alternately large storage capacity recordable media discs. According to this embodiment, the at least one hot swappable PnP media duplication drive includes a connection port incorporating a Serial AT Attachment connector.

According to another embodiment, a docking system is also disclosed herein. The docking system includes a coupling of a laptop to the docking system, a connecting means for a power supply to the docking system, a powering on of the docking system a using of the docking system to complete a task and a saving of the task to a HDD coupled to the docking system.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a lap-top expansion, constructed and operative according to the teachings of the present disclosure.

FIG. 1 is a perspective view of the docking system during an ‘in-use’ condition, according to an embodiment of the disclosure.

FIG. 2 is a side view of the docking system of FIG. 1, according to an embodiment of the present disclosure.

FIG. 3 is a rear view of the docking system of FIG. 1, according to an embodiment of the present disclosure.

FIG. 4A is a rear view of the docking system of FIG. 1, according to an embodiment of the present disclosure.

FIG. 4B is a front view of the docking system of FIG. 1, according to an embodiment of the present disclosure.

FIG. 5 is a flow diagram illustrating a method of use for the docking system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an expansion device coupled to a lap-top and more particularly to a lap-top expansion as used to improve the data sharing across lap-tops with physical, and operational design differences use by various lap-top manufactures.

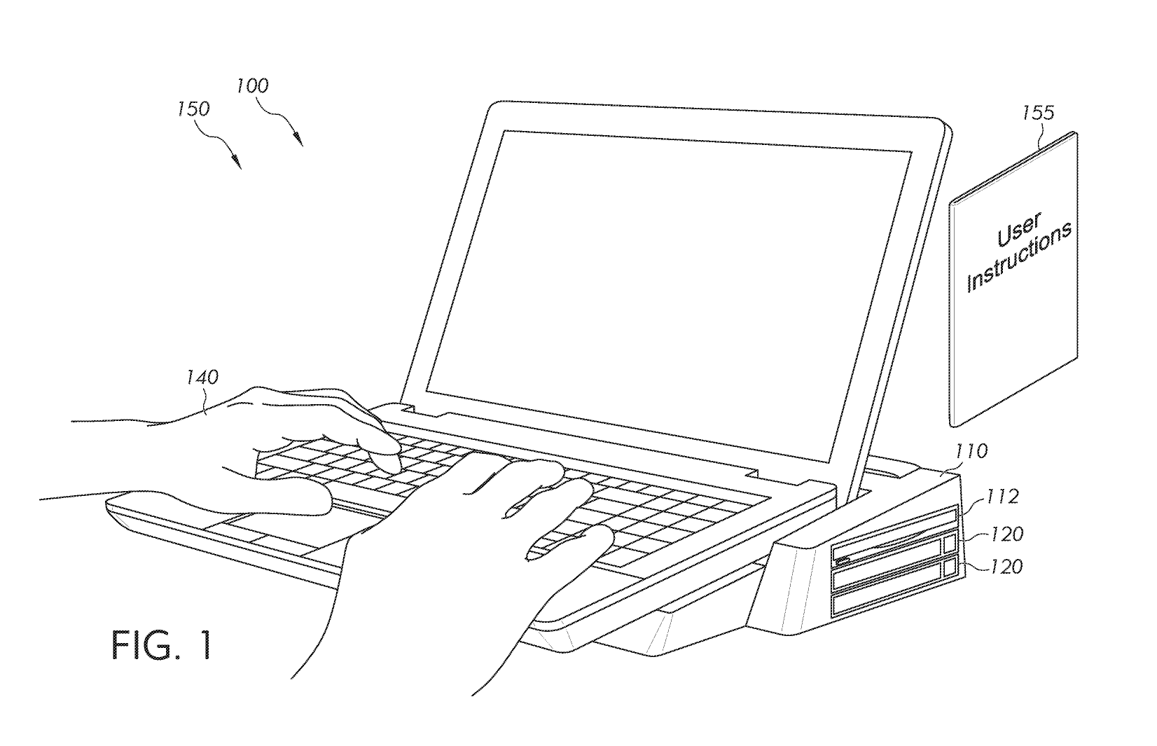

Referring now more specifically to the drawings by numerals of reference, there is shown in FIGS. 1-4B, various views of a docking system 100. FIG. 1 shows a docking system 100 during an ‘in-use’ condition 150, according to an embodiment of the present disclosure. Here, the docking system 100 may be beneficial for use by a user 140 to share data across lap-tops with physical, and operational design differences. As illustrated, the docking system 100 may include a customizable attachable housing 110, at least one hot swappable PnP drive dock 120, and a power supply 130. The customizable attachable housing 110 may be structured and arranged to allow for coupling to different lap-top manufactures housing designs.

The docking system 100 may be arranged as a kit 105. In particular, the docking system 100 may further include a set of instructions 155. The instructions 155 may detail functional relationships in relation to the structure of the docking system 100 (such that the docking system 100 can be used, maintained, or the like, in a preferred manner).

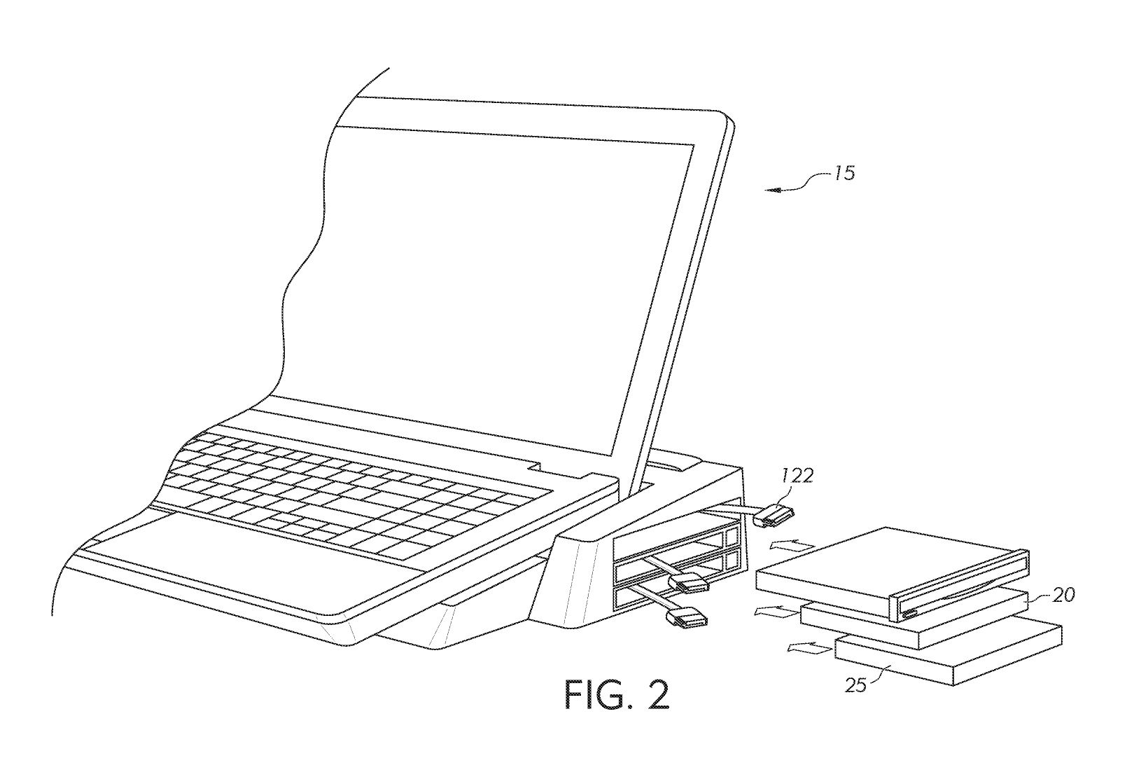

FIG. 2 shows the docking system 100 of FIG. 1, according to an embodiment of the present disclosure. As above, the docking system 100 may include the customizable attachable housing 110, the at least one hot swappable PnP drive dock 120, and the power supply 130. The customizable attachable housing 110 may include at least one hot swappable PnP media duplication drive 112 for allowing the user 140 to alternatively coping data to digital media, the customizable attachable housing 110 may further include multiple hot swappable PnP drive docks 120 to increase internal data storage space. The hot swappable PnP drive docks 120 which may allow for HDD (Hard Disk Drive) 20 and SDD (Solid State Drive) 25 to be coupled to the customizable attachable housing 110 with Serial AT Attachments 122.

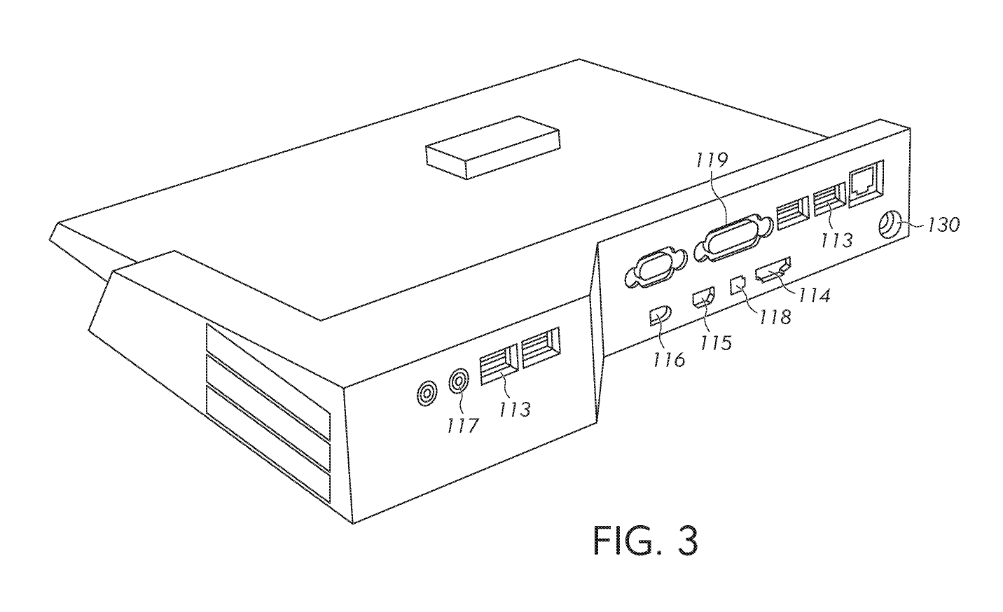

FIG. 3 is a rear view of the docking system of FIG. 1, according to an embodiment of the present disclosure. The customizable attachable housing 110 may include at least one universal serial bus port 113, for providing connection to non-standard lap-top 10, also allowing for increases the number of universal serial bus ports 113 available to accept external USB compliant hardware. The customizable attachable housing 110 may further include a HDMI output port 114 useful for connecting to an external monitor. The customizable attachable housing 110 may even further include a dual-protocol I/O connection port 115 for permitting a user to couple a non-stranded lap-top 10 which only can be coupled with a dual-protocol I/O connection port 115.

The customizable attachable housing 110 may include a fire wire connection port 116 for maintain backward compatibility with older technology. The customizable attachable housing 110 may further include a microphone input port 117 for saving voice recordings and the like. The customizable attachable housing 110 may even further include an optical audio port 118 for improved audio sound production when connect to an external speaker system. The customizable attachable housing 110 may also include a parallel port 119 which may be useful for allowing a user 140 to connect a printer.

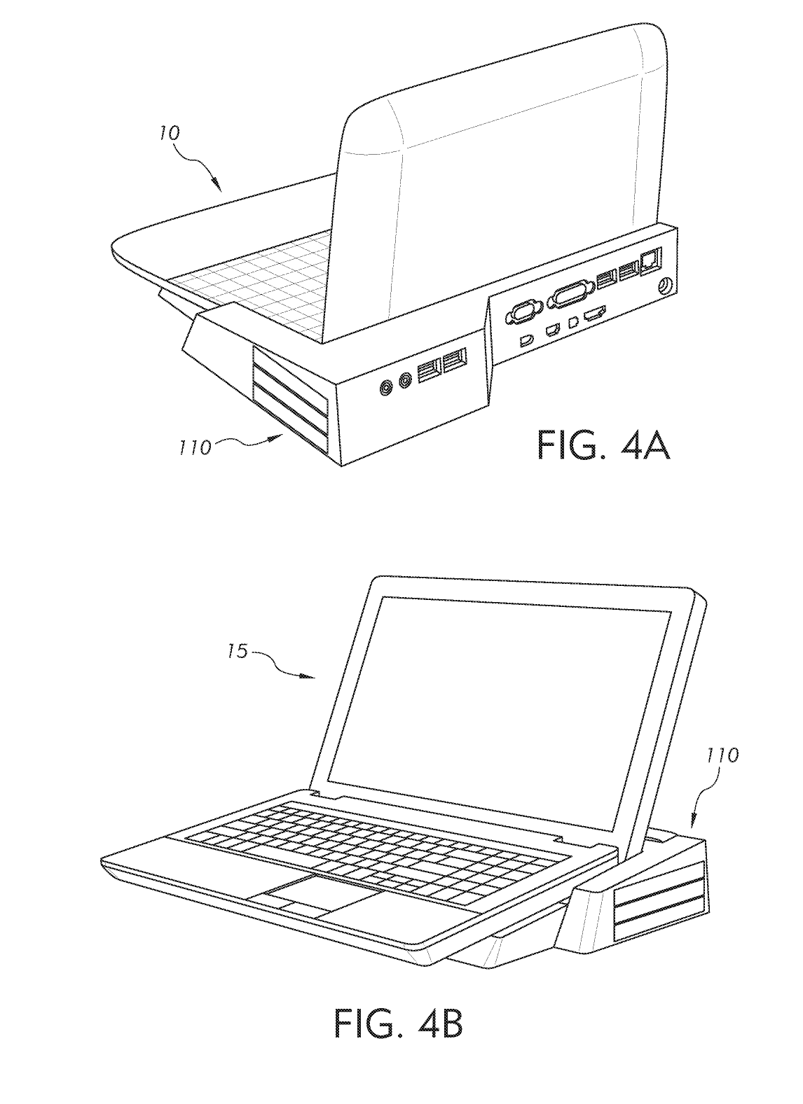

FIG. 4A is a rear view of the docking system of FIG. 1, according to an embodiment of the present disclosure. The customizable attachable housing 110 is coupled to a non-standard lap-top 10 for illustrating the ability to connect a variety of different lap-top designs. Also, illustrating a standard power connector 130 for allowing a user 140 to connect a standard lap-top power supply.

FIG. 4B is a front view of the docking system of FIG. 1, according to an embodiment of the present disclosure. The customizable attachable housing 110 coupled to a standard lap-top 15 for illustrating the ability to connect a variety of different lap-top designs.

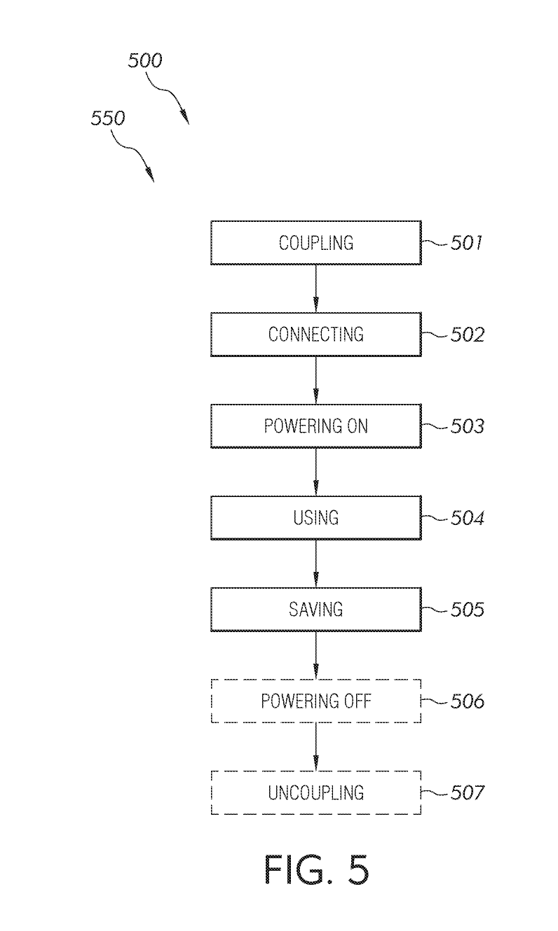

FIG. 5 is a flow diagram illustrating a method 500 for a docking system 100, according to an embodiment of the present disclosure. In particular, the method 500 for a lap-top docking system 100 may include one or more components or features of the docking system 100 as described above. As illustrated, the method 500 for sharing of data across multiple lap-tops may include the steps of: step one 501, coupling; step two 502, connecting; step three 503, powering on; step four 504, using; step five 505, saving; Step six 506, powering off; and step seven 507, uncoupling.

It should be noted that steps 506, and 507 are an optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for a lap-top docking system (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A docking system for docking a lap-top computer, the docking system comprising:
a customizable attachable housing including,
at least one hot swappable PnP drive dock coupled to the customizable attachable housing, the hot swappable PnP drive dock including,
a universal HDD port configured to accept either a 2.5-inch and alternately a 3.5-inch HDD, designed to maintain a large amount of data storage while traveling,
a multi-function communication device configured to allow wireless and LAN line internet connectivity, and
a power supply configured to supply power to the docking system and the laptop computer when coupled.

2. The docking system of claim 1, wherein the customizable attachable housing includes at least one hot swappable PnP media duplication drive.

3. The docking system of claim 2, wherein the customizable attachable housing further includes at least one universal serial bus port useful for connecting to the lap-top computer.

4. The docking system of claim 3, wherein the customizable attachable housing further includes a HDMI output port allowing for a user to output data to an auxiliary monitor.

5. The docking system of claim 1, wherein the at least one hot swappable PnP drive dock suitable to be coupled to a SSD drive allowing for an increase in speed when saving and retrieving data through the docking system.

6. The docking system of claim 5, wherein the at least one hot swappable PnP drive dock includes a connection port incorporating Serial AT Attachment for HDD, and SSD coupling.

7. The docking system of claim 6, wherein the at least one hot swappable PnP drive dock includes a connection port incorporating Integrated Drive Electronic allowing for backward compatibility.

8. The docking system of claim 4, wherein the customizable attachable housing further includes a dual-protocol I/O connection port allowing for non-PC compatible storage drive connections.

9. The docking system of claim 8, wherein the customizable attachable housing further includes a fire wire connection port to maintain backward compatibility.

10. The docking system of claim 9, wherein the customizable attachable housing also includes a parallel port useful for allowing a user to connect to a printer.

11. The docking system of claim 1, wherein the at least one universal serial bus port is USB 3.0 compatible for increased data transfer speeds to USB 3.0 compatible devices.

12. The docking system of claim 1, wherein the customizable attachable housing includes a microphone input port for inputting and saving voice recordings.

13. The docking system of claim 2, wherein the at least one hot swappable PnP media duplication drive supports large storage capacity recordable media.

14. The docking system of claim 2, wherein the at least one hot swappable PnP media duplication drive supports DVD technology.

15. The docking system of claim 2, wherein the at least one hot swappable PnP media duplication drive includes a connection port incorporating a Serial AT Attachment connector.

16. The docking system of claim 1, wherein the customizable attachable housing includes an optical audio port for improved audio sound production.

17. A docking system for docking a lap-top computer, the docking system comprising:
a customizable attachable housing including, at least one hot swappable PnP media duplication drive having support for large storage capacity recordable media with a connection port incorporating a Serial AT Attachment connector, at least one universal serial bus port with a rating of USB 3.0 compatibility for increased data transfer speeds over USB ports, which are useful for connecting to the lap-top computer, a HDMI output port allowing for a user to output data to an auxiliary monitor, a dual-protocol I/O connection port allowing for non-PC compatible storage drive connections, a fire wire connection port to maintain backward compatibility, a parallel port useful for allowing the user to connect to a printer, a microphone input port for inputting and saving voice recordings, and an optical audio port for improved audio sound production;
at least one hot swappable PnP drive dock coupled to the customizable attachable housing, the hot swappable PnP drive dock having a connection port incorporating Serial AT Attachment for HDD, and SSD coupling, at least one hot swappable PnP drive dock suitable to be coupled to a SSD drive allowing for an increase in speed when saving and retrieving data through the docking system, at least one hot swappable PnP drive dock including a connection port incorporating Integrated Drive Electronic allowing for backward compatibility;
a universal HDD port configured to accept a 2.5-inch and alternately a 3.5-inch HDD, designed to maintain a large amount of data storage while traveling having, a second hot swappable PnP drive dock including a connection port incorporating Serial AT Attachment for HDD, and SSD coupling,
a multi-function communication device configured to allow wireless and LAN line internet connectivity, and
a power supply configured to supply power to the docking system and the laptop computer when coupled.

18. The docking system of claim 17, further comprising set of instructions; and
wherein the docking system is arranged as a kit.

19. A method of use for a docking system, the method comprising the steps of:
coupling a laptop to a docking system,
connecting a power supply to the docking system,
powering on the docking system,
using the docking system to complete a task, and
saving the task to a HDD coupled to the docking system.

20. The method of claim 19, further comprising the steps of:
powering off the docking system, and
uncoupling the laptop from the docking system.
